(19) United States
(12) Patent Application Publication
(10) Pub. No.: US 2008/0070594 A1
(43) Pub. Date: Mar. 20, 2008

(54) SYSTEM AND METHOD FOR PAGING GROUP DIFFERENTIATION BY QoS SET GROUPING

(75) Inventor: Phillip Barber, Frisco, TX (US)

Correspondence Address: AKIN GUMP STRAUSS HAUER & FELD, LLP, P O BOX 688, DALLAS, TX, 75313-0688, US

(73) Assignee: Futurewei Technologies, Inc., Plano, TX (US)

(21) Appl. No.: 11/854,798

(22) Filed: Sep. 13, 2007

Related U.S. Application Data
(60) Provisional application No. 60/825,835, filed on Sep. 15, 2006.

(51) Int. Cl. H04Q 7/20

(52) U.S. Cl. 455/458

(57) ABSTRACT

A system for assigning a subscriber device into a paging group in a wireless communication network. The system comprises a network entity that creates paging group information for the subscriber device using at least one Quality of Service (QoS) requirement, and sends the paging group information to the subscriber device.

### TECHNICAL FIELD OF THE INVENTION

The present invention relates generally to wireless communication systems, and more particularly, relates to a versatile system for assignment of paging groups by Quality of Service (QoS) requirements in wireless communication systems.

### BACKGROUND OF THE INVENTION

In a wireless communication network, an Access Service Network (ASN), whether fixed or mobile, and subscriber devices, typically with little current data traffic requirements, may enter into periods of scheduled absence from the network in order to both conserve power and decrease air interface resource utilization on the network. During these periods of scheduled absence, a subscriber device may power down one or more components or perform other activity during which the device is no longer listening to, or making transmissions to the ASN. In conventional wireless ASNs, these pre-negotiated periods of absence are known as Idle or Paging intervals.

In order to preserve the subscriber device's presence on the network, the subscriber device must re-awaken and listen to downlink transmissions of the ASN at very specific, previously negotiated intervals. Also, any transmissions from the ASN intended for the subscriber device must be sent during a period when the subscriber device is expected to be available and listening for such transmissions. In this way, the subscriber device and the ASN are synchronized in their periods of absence and transmission/reception. Failure of the subscriber device to become available to the ASN at the scheduled intervals may result in impairment of service and disconnect from the ASN.

A conventional method of setting the schedule for such periods and synchronizing their values is by assigning the subscriber device to a Paging Group with specific, well publicized, or negotiated timing parameters. Typically, these Paging Groups are assigned on a geographic basis alone, in order to contain geographic and physical transmission boundaries to which an ASN expects to locate and notify a given subscriber device. However, in networks that support multiple subscriber devices that have differentiated and dynamic QoS requirements, uniform timing for these Paging Groups intervals creates a performance constraint on both subscriber device QoS and network performance. When geography alone is used in Paging Group assignment for idle subscriber devices, devices with different QoS requirements or characteristics get lumped together.

Depending on ASN configuration for Paging Group interval, this conventional method may have the following negative effects: 1) if Paging Group interval is set to a “least common value” to accommodate all QoS requirements (i.e. anticipating a mix of PTT, VoIP, Best Effort data, streaming video, and real-time video, an operator sets the Paging Group interval to 30 ms), then subscriber devices see decreased power savings and the ASN sees increased unproductive transmission overhead as many subscriber devices with more relaxed QoS requirements are forced to awaken and listen to transmissions even though they have no service that requires such frequent availability, and the ASN is forced to make unnecessary and unproductive transmissions to these relaxed requirement subscriber devices; and 2) if Paging Group interval is set to a value larger than a “least common value”, some subscriber devices with stringent QoS requirements will not be notified in a timely manner of pending data traffic and their QoS performance will suffer.

Thus, ASNs in wireless networks encounter problems of decreased efficiency associated with failure to accommodate differences that QoS requirements impose on idle mode operation.

Therefore, there is a need to provide a versatile system by which power consumption of a subscriber device and unproductive and unnecessary ASN transmissions may be substantially decreased in a wireless communication network.

### SUMMARY OF THE INVENTION

A system, comprising various methods and constructs, for assigning a subscriber device into a paging group in a wireless communication network is provided. The system comprises structure (i.e., a network entity) that creates paging group information for the subscriber device using a Quality of Service (QoS) requirement, and an element that sends the paging group information to the subscriber device.

In various embodiments, the element that sends the paging group information will be incorporated into, or an integral part of, the structure that creates the paging group information. In certain embodiments, geographic information may also be utilized in creation of the paging group information.

The following description and drawings set forth in detail these and other illustrative embodiments of the invention. The disclosed embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram depicting an example of paging groups according to the present invention; and

FIG. 2 and FIG. 3 are flow diagrams depicting embodiments for assigning a mobile station into a paging group using Quality of Service (QoS) requirements according to the present invention;

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

The present invention includes a system for paging group differentiation by Quality of Service (QoS) set grouping. The system uses QoS as a determining factor to assign a subscriber device into a paging group. The present invention may use QoS requirements of a subscriber device as a determining factor in creation, negotiation and assignment of paging groups in a communications network. Further, the present invention maximizes power conservation on subscriber devices, minimizes unnecessary and unproductive ASN transmissions, and optimally meets idle mode subscriber device QoS requirements.

A subscriber device within a wireless communication network may arrange periods of absence from wireless communication services provided by one or more Access Points (APs) or Base Stations (BSs). That is, a subscriber device does not have communication traffic for a period of time, and switches to an idle mode or paging mode. When a subscriber device enters into an idle period, the subscriber device may be tracked at a paging group comprising one or more APs or BSs.

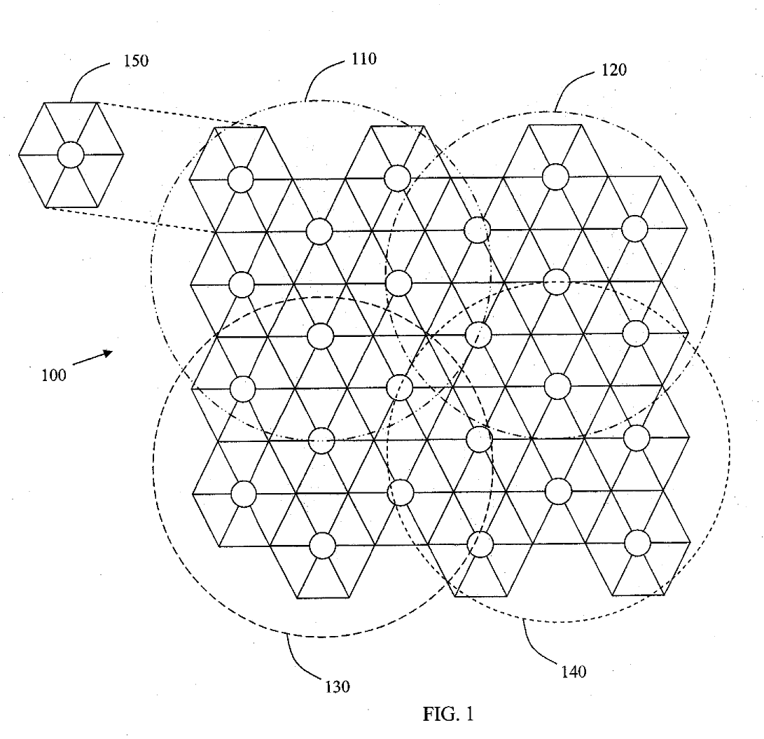

During the idle period, the subscriber device may receive periodic notification from the wireless communication network. Conventionally, the notification received by the subscriber device may group the subscriber device into a certain paging group using geographic information. FIG. 1 describes paging group examples where a coverage area (100) may be grouped to four paging groups, paging group (110), paging group (120), paging group (130), and paging group (140), based on set criteria. Each paging groups may include a number of cells, and each cell (150) is covered by 6 BS.

Comparatively, in the embodiments of the present invention, a subscriber device may be grouped using QoS requirements, or combination of QoS and geographic requirements, and each paging group may be delineated and reformed by a set of QoS notification requirements common to a set of subscriber devices. Then each subscriber device may be notified of pending downlink transmissions in timing, consistent with a set of QoS requirements.

The present invention may be applied in any networks using paging groups for mobiles in an idle mode. These networks include, but not limited to, 3GPP, 3GPP2, and WiMAX.

One embodiment of the present invention may be used in IEEE 802.16 networks. In IEEE 802.16 mobile networks, at the time that a policy entity either on an mobile station (MS) or on a network makes a decision to transition the MS operating mode to Idle Mode operation, and processes that decision using DREG MAC management control messages, the network may use QoS parameter information for one or more of the active service flows for the MS to process the Idle Mode transaction and, through a Paging Information TLV in a DREG-CMD message, assign the MS to a Paging Group not just with appropriate geographic coverage scope, but also with appropriate QoS parameters, including but not limited to, Paging Cycle, Paging Offset, and Paging Interval Length, to align with the constraints of the QoS parameters of those active service flows. As a result, the MS may achieve maximum power conservation, while simultaneously ensuring minimum disruption to any active service flow, should a new downlink data plane communication arise. In addition, the embodiments of the present invention may have an additional positive affect to minimize network MAC management control overhead by reducing the frequency of processing of Idle Mode Location Update events.

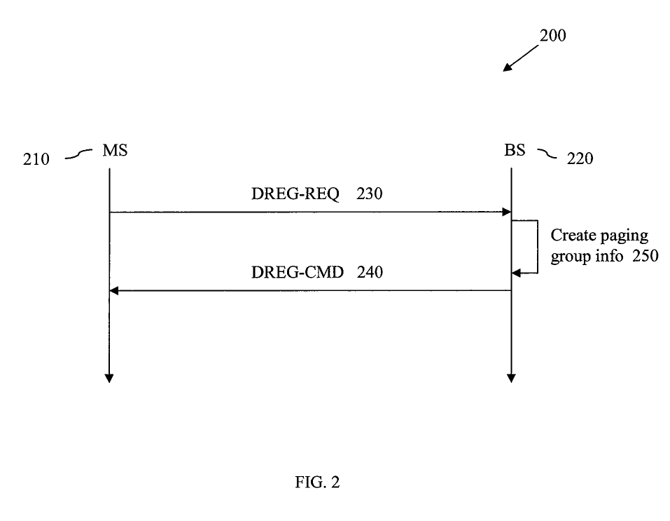

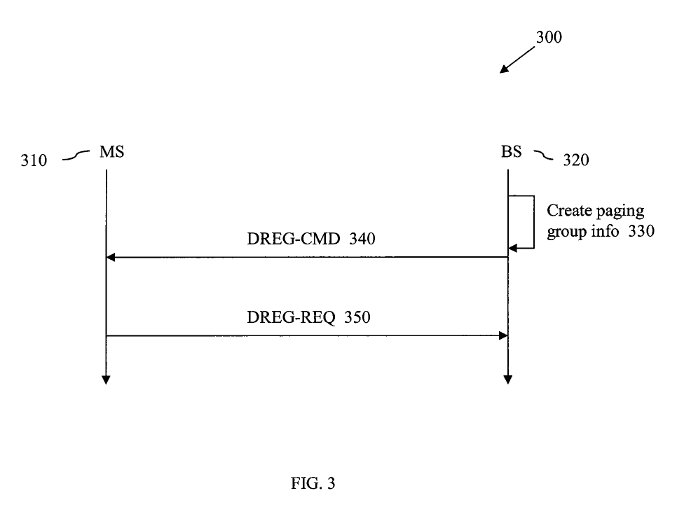

FIGS. 2 and 3 are flow diagrams (200) and (300) illustrating embodiments for assigning a Mobile Station (MS) into a paging group using QoS requirements when initiating an idle mode for the MS in an IEEE 802.16 network according to the present invention. According to IEEE 802.16, an idle mode of an MS may be initiated either by the MS itself through an appropriately configured DREG-REQ message or a by a serving Base Station (BS) of the MS through an unsolicited, appropriately configured DREG-CMD message.

In FIG. 2, when an MS (210) requests to initiate an idle mode, the MS (210) may signal intent to begin the idle mode by sending a DREG_REQ message, including Action Code value of 0×01 request to enter Idle Mode operation, to a serving BS (220) in step (230). The serving BS (220), upon receipt of the DREG-REQ message, may create paging information for the MS (210) using QoS requirements of the MS (210) in step (240). The paging information may include paging cycle, paging offset, paging group ID, and paging interval length, etc. In step (250), the serving BS (220) may respond to the request of the MS (210) by sending a DREG-CMD message to the MS (210), carrying the paging information created.

Table 1 illustrates an embodiment of format of a DREG-CMD message.

TABLE 1

| Syntax | Size (bit) |
|---|---|
| DREG-CMD_Message_Format( ) { | — |
| Management Message Type = 29 | 8 |
| Action Code | 8 |
| TLV encoded parameters | variable |
| } | — |

Inclusion of Action Code value 0×05 instructs the MS to initiate Idle Mode operation. The TLV encoded parameters in Table 1 may comprise the paging information described previously, which may be defined using QoS requirements of the MS (210). The QoS requirements may include, but not limited to, Traffic Priority, Maximum Sustained Traffic Rate, Maximum Traffic Burst, Minimum Reserved Traffic Rate, Vendor-specific QoS parameters, Tolerated Jitter, Maximum Latency, Unsolicited Grant Interval, Unsolicited Polling Interval, Global Service Class Name, and Paging Preference.

These QoS parameters may vary widely by application types to which they are created to support. For example, a service flow created to accommodate the downlink portion of an active VoIP service may have much more stringent requirements for priority, tolerated jitter, and maximum latency than a downlink service flow created to accommodate best effort data services, which may have little if any QoS constraints. Similarly, requirements for PTT, VoIP, video conferencing, streaming video and best effort data application services may all have differentiated service flow QoS requirements in an 802.16 mobile system.

Similarly, in a case when a serving BS (320) initiates an idle mode of an MS (310), as illustrated in FIG. 3, the serving BS (320) may create in step (330) paging information for the MS (310) using QoS requirements of services for the MS (310), and signal for the MS (310) to begin idle mode operation by sending a DREG-CMD message to the MS (310) in step (340), with Action Code 0×05 and carrying the paging information created. The MS (310) may respond to the serving BS (320) with a DREG-REQ message in step (350), and enters idle mode.

An MS in an idle mode may also receive periodically messages of notification which update or change the paging group information of the MS. In one embodiment, a BS may broadcast a paging message during the Paging Listening Interval of an MS, requesting the MS to update or change its paging group information. Upon receipt of response from the MS, the BS may send the updated paging group information to the MS, where the updated paging group information is created using QoS requirements of the MS. For example, in IEEE 802.16, a BS may transmit a RNG-REQ message, carrying updated paging group information, in response to a received RNG-REQ message from an MS.

The assignment of an MS into a paging group may be made a BS of the MS, as illustrated in FIGS. 2 and 3, or alternatively, an Access Service Network (ASN), a paging controller, or any equivalent network entity. Furthermore, the assignment may be made using one or more QoS requirements of the MS, or combination one or more QoS requirements and geographic parameters.

The notification for a subscriber device may be on a service basis or a device basis. In an embodiment for IEEE 802.16 mobile networks, where Paging Group assignment is made on a per-MS basis, the network decision on Paging Group assignment based in part on QoS parameter differentiation may be based on the QoS parameters of the most restrictive active service flow from the set of all active service flows for the MS, thereby assuring that in most circumstances the MS may be notified of pending downlink data through PAG-ADV MAC management messages in sufficient time to meet even the most critical of its active service flow QoS requirements.

For instance, for a single subscriber device with multiple concurrent services of different QoS requirements, the subscriber device may be assigned to a paging group using a most stringent value of the QoS requirements for all services on the single subscriber device. The subscriber device may also be assigned to a paging group using other subjective QoS decision criteria.

Table 2 illustrates an example using a most stringent value of the QoS requirements for multiple services on a single subscriber device, wherein the video transfer may be chosen as it has the most stringent value of the QoS requirement among all four services in the subscriber device.

TABLE 2

| Service | Time Interval (ms) |
|---|---|
| Voice | 250 |
| Text Data | 1000 |
| Video | 150 |
| Geographic parameter | 150000 |

In another example, if an MS has an active service flow configured to support a VoIP application service where the maximum latency was 150 ms, and another configured to support a best effort data service where there was no specified maximum latency, then the network may assign the MS to a paging group with a Paging Cycle, Paging Offset, and Paging Interval Length sufficiently less than 150 ms such that the MS may be notified via PAG-ADV of the pending downlink data, re-enter the network from an Idle Mode, and begin receiving the pending downlink data all within the specified maximum latency for the VoIP service.

Mobile networks that assign Paging Group on a per-service flow basis may not need to make such least-common-denominator QoS distinction but instead require an MS to monitor the Paging Group for each of its service flows.

In one embodiment of the present invention, alignment of Paging Group to QoS requirement may be timing based. In IEEE 802.16 for example, the Paging Cycle of a Paging Group defines the frequency that a network may transmit, and an MS makes itself available to the network to receive, PAG-ADV MAC management control messages.

In another embodiment in a network with a mix of MSs supporting a variety of differently QoS constraining service flows—e.g. some VoIP MS, some PTT MS, some streaming video MS, some best effort data MS, —the ability for a network to assign individual MS to a Paging Group that mirrors the MS individual QoS requirements (conventionally the MSs are grouped by common QoS constraint) provides a way to allow those MSs with less stringent QoS requirements to reduce the frequency of network operation, conserving more power and reducing the overhead on the network.

Further, in IEEE 802.16 mobile networks, even for those MSs with more restrictive QoS requirements at the time of entry into Idle Mode operation, as those service flows are dynamically changed to be inactive and are transitioned to admitted or provisioned status, a network, using the Paging Information TLV in RNG-RSP MAC management control messages, may dynamically reallocate an MS to a Paging Group with less frequent cycles, matching the MS less restrictive QoS requirements for the remaining active service flows.

In addition, an IEEE 802.16 mobile network may dynamically create new Paging Groups in response to a decision to transition an MS to Idle Mode operation. Similarly, the network may dynamically eliminate Paging Groups in response to MS exiting from Idle Mode operation. Network dynamic creation of Paging Groups with associated Paging Cycles, Paging Offsets, and Paging Interval Lengths provides a method for the network to more appropriately tailor the available set of Paging Groups to the changing set of MS, with differing QoS requirements, which may exist on the network at any point in time. In 802.16 mobile networks, the benefit of dynamic Paging Group creation and elimination is, as previously disclosed, to reduce Paging Group ID advertisement overhead in the DCD and PAG-ADV MAC management, and to reduce Paging Group management complexity in the network.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for assigning a subscriber device into a paging group in a wireless communication network, comprising the steps of:
creating paging group information for the subscriber device, utilizing a Quality of Service (QoS) requirement; and
sending the paging group information to the subscriber device.

2. The method of claim 1, wherein the Quality of Service (QoS) requirement comprises: Traffic Priority, Maximum Sustained Traffic Rate, Maximum Traffic Burst, Minimum Reserved Traffic Rate, Vendor-specific QoS parameter, Tolerated Jitter, Maximum Latency, Unsolicited Grant Interval, Unsolicited Polling Interval, Global Service Class Name, or Paging Preference.

3. The method of claim 1, wherein the paging group information is sent to the subscriber device using a communication message.

4. The method of claim 3, wherein the communication message is a DREG-CMD message.

5. The method of claim 1, wherein the subscriber device is transitioning from an operating mode to an idle mode.

6. The method of claim 1, wherein the subscriber device is in an idle mode.

7. A method for assigning a subscriber device into a paging group in a wireless communication network, comprising the steps of:
creating paging group information for the subscriber device, utilizing a Quality of Service (QoS) requirement and a geographic parameter; and
sending the paging group information to the subscriber device.

8. The method of claim 7, wherein the Quality of Service (QoS) requirement comprises: Traffic Priority, Maximum Sustained Traffic Rate, Maximum Traffic Burst, Minimum Reserved Traffic Rate, Vendor-specific QoS parameter, Tolerated Jitter, Maximum Latency, Unsolicited Grant Interval, Unsolicited Polling Interval, Global Service Class Name, or Paging Preference.

9. The method of claim 7, wherein the paging group information is sent to the subscriber device using a communication message.

10. The method of claim 9, wherein the communication message is a DREG-CMD message.

11. The method of claim 7, wherein the subscriber device is transitioning from an operating mode to an idle mode.

12. The method of claim 7, wherein the subscriber device is in an idle mode.

13. A system for assigning a subscriber device into a paging group in a wireless communication network, comprising:
a structure adapted to create paging group information for the subscriber device, utilizing a Quality of Service (QoS) requirement; and
an element adapted to send the paging group information to the subscriber device.

14. The system of claim 13, wherein the structure comprises a base station, an access service network, or a paging controller.

15. The system of claim 14, wherein the element comprises the same base station, an access service network, or a paging controller as the structure.

16. The system of claim 13, wherein the QoS requirement comprises: Traffic Priority, Maximum Sustained Traffic Rate, Maximum Traffic Burst, Minimum Reserved Traffic Rate, Vendor-specific QoS parameter, Tolerated Jitter, Maximum Latency, Unsolicited Grant Interval, Unsolicited Polling Interval, Global Service Class Name, or Paging Preference.

17. The system of claim 13, wherein the element sends the paging group information to the subscriber device using a communication message.

18. The system of claim 17, wherein the communication message is a DREG-CMD Message.

19. The system of claim 13, wherein the subscriber device is transitioning from an operating mode to an idle mode.

20. The system of claim 13, wherein the subscriber device is in an idle mode.

21. A method for altering paging group information of a subscriber device in idle mode in a wireless communication network, comprising the steps of:
creating paging group information for the subscriber device, utilizing a Quality of Service (QoS) requirement;
paging the subscriber device; and
sending the paging group information to the subscriber device upon response of the subscriber device.

22. The method of claim 21, wherein the Quality of Service (QoS) requirement comprises: Traffic Priority, Maximum Sustained Traffic Rate, Maximum Traffic Burst, Minimum Reserved Traffic Rate, Vendor-specific QoS parameter, Tolerated Jitter, Maximum Latency, Unsolicited Grant Interval, Unsolicited Polling Interval, Global Service Class Name, or Paging Preference.

23. The method of claim 21, wherein the paging group information is sent to the subscriber device using a communication message.

24. The method of claim 23, wherein the communication message is an RNG-RSP message.
